(19) United States
(12) Patent Application Publication
(10) Pub. No.: US 2024/0243495 A1
(43) Pub. Date: Jul. 18, 2024

(54) CONDUCTIVE GASKET FOR USE WITH SPRING-BIASED CONTACTS

(71) Applicant: CommScope Technologies LLC, Claremont, NC (US)

(72) Inventors: Fan He, Suzhou (CN); Pertti Leinonen, Sotkamo (FI); Ligang Wu, Suzhou (CN); Yrjo Erkki Hugg, Arcore (IT)

(21) Appl. No.: 18/407,709

(22) Filed: Jan. 9, 2024

(30) Foreign Application Priority Data
Jan. 12, 2023 (IT) 102023000000273

(51) Int. Cl. H01R 12/55; H01R 13/03; H01R 13/17

(52) U.S. Cl. CPC H01R 12/55; H01R 13/03; H01R 13/17; H01Q 1/246

(57) ABSTRACT

An assembly for a base station antenna arrangement includes: a radio having a cover with a hole and a printed circuit board (PCB) positioned below the cover, wherein the PCB has first and second contact pads; a pogo-pin connector having a spring-loaded inner contact and an outer contact that circumferentially surrounds the inner contact, wherein the inner contact extends through the hole in the cover and engages the first contact pad of the PCB; and a gasket formed of a conductive elastomer, the gasket including a lower ring and an upper ring, wherein the lower ring is positioned in the hole in the cover and engages the second contact pad of the PCB and the upper ring engages the outer contact to establish an electrical connection between the outer contact and the second contact pad, the gasket further including a skirt that extends radially outwardly from and circumferentially surrounds the upper ring, the skirt engaging the cover of the radio.

### RELATED APPLICATION

The present application claims priority from and the benefit of Italian Patent Application No. 102023000000273, filed Jan. 12, 2023, the disclosure of which is hereby incorporated herein by reference in full.

### FIELD

The present invention relates to cellular communications systems and, more particularly, to base station antennas having active antenna modules

### BACKGROUND

Cellular communications systems are well known in the art. In a cellular communications system, a geographic area is divided into a series of regions that are referred to as “cells” which are served by respective base stations. Each base station may include one or more base station antennas that are configured to provide two-way radio frequency (“RF”) communications with mobile subscribers that are within the cell served by the base station. In many cases, each base station is divided into “sectors.” In perhaps the most common configuration, a hexagonally-shaped cell is divided into three 120° sectors, and each sector is served by one or more base station antennas. Typically, the base station antennas are mounted on a tower or other raised structure, with the radiation patterns (also referred to herein as “antenna beams”) that are generated by the base station antennas directed outwardly. Base station antennas are often implemented as linear or planar phased arrays of radiating elements.

With the introduction of fifth generation (“5G”) cellular technologies, base station antennas are now routinely being deployed that have active beamforming capabilities. Active beamforming refers to transmitting RF signals through a multi-column array of radiating elements in which the relative amplitudes and phases of the sub-components of an RF signal that are transmitted (or received) through the different radiating elements of the array are adjusted so that the radiation patterns that are formed by the individual radiating elements constructively combine in one or more desired directions to form narrower antenna beams that have higher gain. With active beamforming, the shape and pointing direction of the antenna beams generated by the multi-column array may, for example, be changed on a time slot-by-time slot basis of a time division duplex (“TDD”) multiple access scheme. Moreover, different antenna beams can be generated simultaneously on the same frequency resource in a multi-user MIMO scenario. More sophisticated active beamforming schemes can apply different beams to different physical resource blocks that are a combination of time and frequency resources by applying the beam vector in the digital domain Base station antennas that have active beamforming capabilities are often referred to as active antennas. When the multi-column array includes a large number of columns of radiating elements (e.g., sixteen or more), the array is often referred to as a massive MIMO array. A module that includes a multi-column array of radiating elements and associated RF circuitry (and perhaps baseband circuitry) that implement an active antenna is referred to herein as an active antenna module. Active antenna modules may be deployed as standalone base station antennas, or may be deployed in larger antenna structures that include additional active antenna modules and/or conventional “passive” antenna arrays that are connected to radios that are external to the antenna structures.

Co-assigned PCT Publication No. PCT/US2022/031902 (incorporated herein by reference in full) discusses a base station antenna arrangement with filter units that are connected with other circuitry in the base station antenna, such as that of a PCB in a radio. The filter units discussed therein include a resonant cavity filter that includes a metal housing having an opening therein and a spring-biased contact that extends through the opening in the metal housing to contact a port of the resonant cavity filter. For example, the filter units may include “pogo-pin” connector assemblies that, for downlink signals, connect a filter of the filter unit to a first external circuit (e.g., a radio) that generates the RF signals that are input to the filter and/or to a second external circuit (e.g., one or more radiating elements) that receives the RF signals output by the filter. For uplink signals, the pogo-pin connector assemblies may receive RF signals from the second external circuit and pass them to the filter and/or may pass the uplink signals from the filter to the first external circuit. The use of pogo-pin contacts can have several advantages over soldered connections: reduced labor cost in manufacturing (as soldering can be a labor-intensive operation); easier replacement of the filter; and reduced volume for the device (as often space is needed for the soldering operation itself).

FIGS. 1A-1C illustrate a pogo-pin assembly 200 such as that discussed in PCT Publication No. PCT/US2022/031902, supra. The pogo-pin assembly 200 can make electrical connections within base station antennas, and in particular between filters and radios, over gaps having different distances, and without soldering. As shown in FIGS. 1A-1C, the pogo pin connector assembly 200 may include a pogo pin connector 210 and a dielectric spacer 260. The pogo pin connector 210 is a tubular structure that includes a barrel 220, a plunger 230, and a spring 240. The barrel 220 has an open interior and a forward (or “distal”) end 222 of the barrel 220 includes an opening 224. The spring 240 and a portion of the plunger 230 are received within the barrel 220. The plunger 230 includes a widened portion 232 that is within the barrel 220. The widened portion 232 may comprise a rear portion of the plunger 230. A forward (or “distal”) end 234 of the plunger 230 extends through the opening 224 in the barrel 220. The barrel 220 includes an inner lip 226 (which defines the opening 224) that has a diameter that is smaller than a diameter of the widened portion 232 of the plunger 230, and hence the inner lip 226 traps the widened portion 232 of the plunger 230 within the interior of the barrel 220. The spring 240 biases the widened portion 232 of the plunger 230 against the inner lip 226 of the barrel 220. When a rearwardly directed force is applied to the plunger 230, the spring 240 is compressed and the plunger 230 moves further into the barrel 220. The spring 240 applies a forwardly directed force on the plunger 230. The barrel 220, plunger 230 and spring 240 may each be made of a conductive material, such as a metal. The pogo pin connector 210 may also include additional elements. For example, as shown in FIG. 1B, the pogo pin connector 210 may include a metal ball 250 that is interposed between the spring 240 and the plunger 230 and/or an 0-ring 228 that abuts the inner lip 226 of the barrel 220.

The pogo pin connector 210 may be mounted in the dielectric spacer 260. The dielectric spacer 260 may be used to electrically isolate the pogo pin connector 210 from surrounding structures, and/or to mount the pogo pin connector 210 in another structure such as, for example, a filter unit according to embodiments of the present invention. As shown in FIG. 1C, the pogo pin connector 210 may also include additional structures, such as a conductive pin 270. The conductive pin 270 may be positioned adjacent the distal end 234 of the plunger 230 and may act as an extension of the plunger 230 so that the plunger 230 may have any desired length. By including the conductive pin 270 in the pogo pin connector assembly 200, a single pogo pin connector 210 may be manufactured and pins 270 having different lengths may be provided that allow the pogo pin connector assembly 200 to make electrical connections over gaps having different distances.

FIGS. 2A-2D illustrate how a pogo-pin assembly may be employed to connect a filter 305 of a base station antenna with a transceiver printed circuit board (PCB) 310 of the radio 320 of a base station antenna. The radio 320 includes a cover 322 with holes 324 that overlies the PCB 310. As shown in FIG. 2C, a pogo-pin assembly 330 extends through one of the holes 324 to connect the filter 305 with the PCB 310. The pogo-pin assembly 330 serves as the inner contact of an overall coaxial connector 340 with an outer contact 345. The outer contact 345 is connected with contact pads 312 on the PCB 310 via a conductive rubber gasket 350. The gasket 350 has an upper ring 352 that encircles a portion of the outer contact 345, and a lower ring 354 that fits within the hole 324 and encircles the lower end of the pogo-pin assembly 330. In some instances, the lower ring 354 is spread radially outwardly and overlies the contact pad 312 of the PCB 310.

As shown in FIG. 2C, there is open space between the outer surface of the lower ring 354 of the gasket 350 and the walls of the hole 324. The presence of this space, which is open to the upper end of the hole 324, can allow signal to leak or escape through the hole (see arrows 360 in FIG. 2C). To combat this, in some instances shielding material 360 will be included radially outward of the upper ring 352 of the gasket 350 and above the surface of the cover 322 adjacent the hole 324. However, such shielding material 360 can add expense to the assembly, and may be prone to slipping out of place. As such, it may be desirable to provide a different solution for shielding when a pogo-pin assembly is employed to connect filters with radio PCBs.

### SUMMARY

As a first aspect, embodiment of the invention are directed to an assembly in a base station antenna arrangement. The assembly comprises: a radio having a cover with a hole and a printed circuit board (PCB) positioned below the cover, wherein the PCB has first and second contact pads; a pogo-pin connector having a spring-loaded inner contact and an outer contact that circumferentially surrounds the inner contact, wherein the inner contact extends through the hole in the cover and engages the first contact pad of the PCB; and a gasket formed of a conductive elastomer, the gasket including a lower ring and an upper ring, wherein the lower ring is positioned in the hole in the cover and engages the second contact pad of the PCB and the upper ring engages the outer contact to establish an electrical connection between the outer contact and the second contact pad, the gasket further including a skirt that extends radially outwardly from and circumferentially surrounds the upper ring, the skirt engaging the cover of the radio.

### BRIEF DESCRIPTION OF THE FIGURES

FIGS. 1A-1C are varied views of a pogo-pin connector assembly used to connect a filter of a base station antenna assembly to a PCB of a radio.

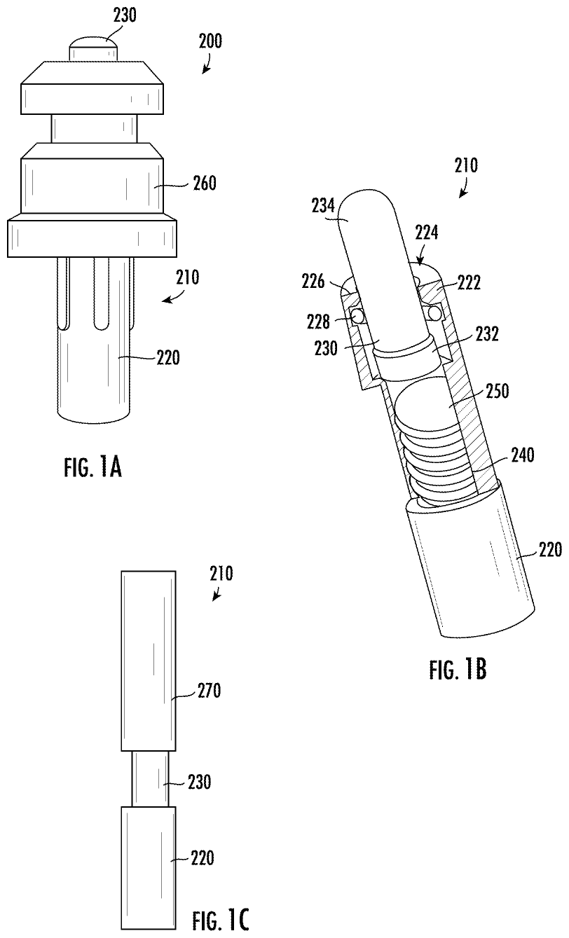

FIGS. 2A-2D are varied views of a pogo-pin connector assembly as shown in FIGS. 1A-1C, with a shielding material being present in FIG. 2D.

FIG. 3 is a perspective view of a gasket that can be used with a pogo-pin connection according to embodiments of the invention.

FIG. 4 is a section view of the gasket of FIG. 3.

FIG. 5 is a section view of the gasket of FIGS. 3 and 4 mounted in the hole of a radio cover to provide shielding to the connection between a pogo-pin connector and a PCB of the radio.

### DETAILED DESCRIPTION

Embodiments of the present invention are described below with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed below can be combined in any way and/or combination with aspects or elements of other embodiments to provide a plurality of additional embodiments.

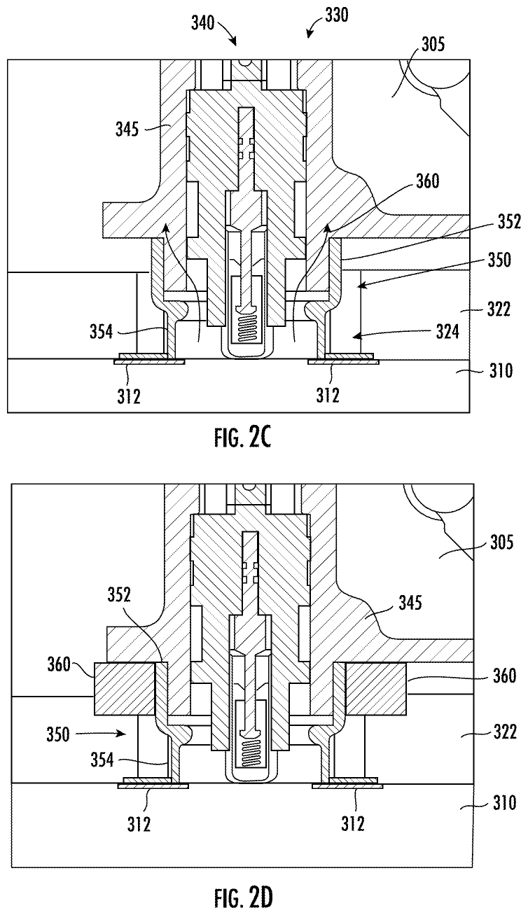

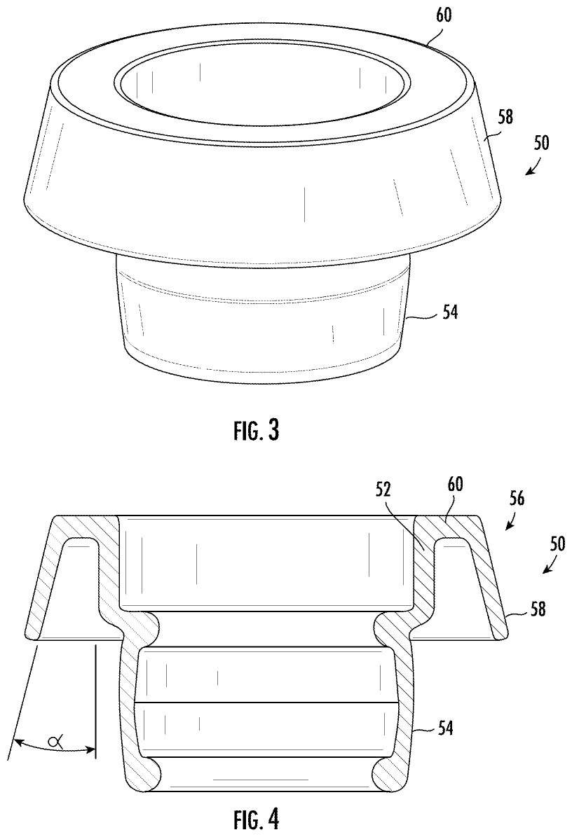

Referring now to the drawings, a gasket, designated broadly at 50, is shown in FIGS. 3 and 4. The gasket 50 is similar to the gasket 350 discussed above, in that it has an upper ring 52 and a lower ring 54 that has a slightly smaller diameter than the upper ring 52. However, the gasket 50 also includes a skirt 56 that is positioned radially outwardly of and circumferentially surrounds the upper ring 52. More specifically, the skirt 56 has a circular lip 58 that encircles the upper ring 52 and an annular transition region 60 that attaches the upper end of the lip 58 to the upper end of the upper ring 52. As can be seen in FIG. 4, the lip 58 of the skirt 56 flares radially outwardly; the oblique angle a defined between the upper ring 52 and the lip 58 is typically between about 10 and 80 degrees (e.g., 30 to 60 degrees).

The gasket 50 is typically formed as a unitary component and may be injection molded. The gasket 50 is typically formed of an elastomeric material, such as rubber, that provides the gasket with resilience under deflection. The material of the gasket 50 is typically filled with a conductive material, such as silver or other conductive metal, to provide shielding properties.

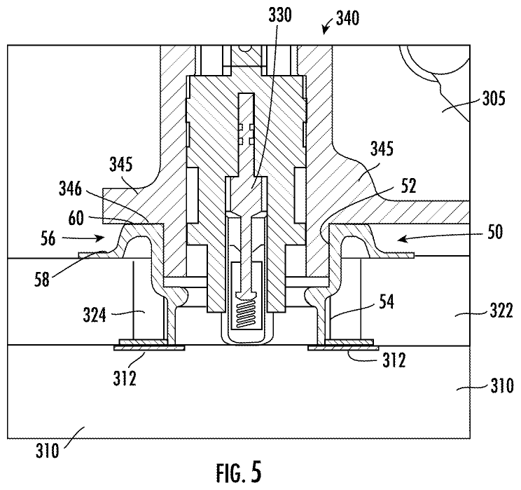

The use of the gasket 50 can be understood with reference to FIG. 5. The gasket 50 is used in conjunction with a pogo-pin connection between a filter and a PCB 310 of a radio. As shown in FIG. 5, the pogo-pin connector 340 has a pogo-pin 330 that serves as the inner contact of the connector 340, and also has an outer contact 345 that is electrically connected with the PCB 310 via the upper and lower rings 52, 54 of the gasket 50 (more specifically, the upper ring 52 encircles the lower end of the outer contact 345, and the lower end of the lower ring 54 deflects to overlie a contact pad 312 in the PCB 310. The transition region 60 of the skirt 56 abuts a shoulder 346 on the outer contact 345. The lower end of the lip 58 engages the upper surface of the radio cover 322 and therefore deflects radially outwardly (in a manner much like that of the lower ring 54).

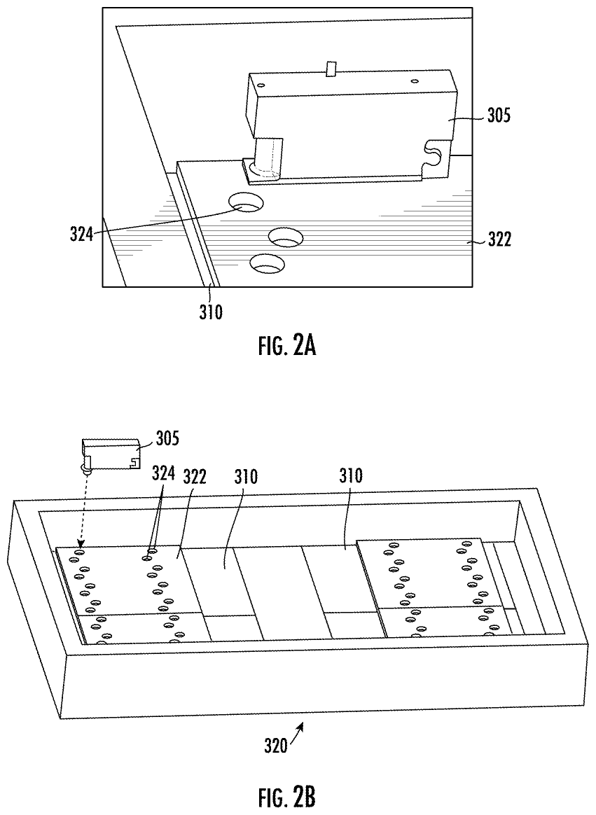

It can be seen that the gasket 50 provides an electrical connection between the outer contact 345 of the pogo-pin connector 340 in much the same manner as the gasket 350 does for the pogo-pin connector 340. However, in addition, the inclusion of the skirt 56 enables the gasket 50 to provide additional shielding by covering the open space between the lower ring 54 and the edge of the hole 324. As a result, the additional shielding material shown in FIG. 2C can be omitted.

Those of skill in this art will understand that the gasket 50 may take other forms. For example, the lip 58 may be perpendicular relative to the transition section rather than extending at an oblique angle. In some embodiments, the lip 58 may have radially-extending slits or slots to facilitate deflection. In other embodiments, the lower ring 54 may not deflect when it contacts the PCB. Other variations may also be apparent to those of skill in this art.

Some embodiments of the present invention are exemplarily described above in combination with the accompanying drawings. Those of ordinary skill in the art to which the present invention belongs should understand that specific structures shown in the above embodiments are merely exemplary, rather than limiting. Moreover, those of ordinary skill in the art to which the present invention belongs can combine a variety of technical features shown above according to a variety of possible manners to constitute new technical solutions or make other modifications, and these new technical solutions are encompassed within the scope of the present invention.

What is claimed is:

1. An assembly in a base station antenna arrangement, comprising:
a radio having a cover with a hole and a printed circuit board (PCB) positioned below the cover, wherein the PCB has first and second contact pads;
a pogo-pin connector having a spring-loaded inner contact and an outer contact that circumferentially surrounds the inner contact, wherein the inner contact extends through the hole in the cover and engages the first contact pad of the PCB; and
a gasket formed of a conductive elastomer, the gasket including a lower ring and an upper ring, wherein the lower ring is positioned in the hole in the cover and engages the second contact pad of the PCB and the upper ring engages the outer contact to establish an electrical connection between the outer contact and the second contact pad, the gasket further including a skirt that extends radially outwardly from and circumferentially surrounds the upper ring, the skirt engaging the cover of the radio.

2. The assembly defined in claim 1, wherein the skirt includes a transition region that extends radially outwardly from the upper ring and a lip that extends radially outwardly from the transition region, and wherein the lip engages the upper surface of the cover.

3. The assembly defined in claim 2, wherein the lip extends from the transition section at an oblique angle.

4. The assembly defined in claim 2, wherein the outer contact includes a shoulder, and wherein the transition region abuts the shoulder.

5. The assembly defined in claim 1, wherein upper ring has a first diameter that is greater than a second diameter of the lower ring.

6. The assembly defined in claim 1, wherein the conductive elastomer comprises rubber.

7. The assembly defined in claim 6, wherein the conductive elastomer comprises a conductive metal.

8. The assembly defined in claim 1, wherein the lower ring has a lower end that deflects radially outwardly to engage the second contact pad of the PCB.

9. The assembly defined in claim 1, wherein the pogo-pin connector connects a filter with the PCB of the radio.

10. The assembly defined in claim 1, wherein the pogo-pin connector further comprises a dielectric member between the inner contact and the other contact.
